(19) United States
(12) Patent Application Publication
(10) Pub. No.: US 2026/0268580 A1
(43) Pub. Date: Sep. 10, 2026

(54) AUGMENTED UNSEEN REGION ALIGNMENT FOR REFERENCE-BASED SCENE INPAINTING

(71) Applicant: NVIDIA Corp., Santa Clara, CA (US)

(72) Inventors: Min-Hung Chen, Zhubei (TW); Chung-Ho Wu, Hsinchu (TW); Yang-Jung Chen, Taoyuan (TW); Ying-Huan Chen, Tainan City (TW); Yen-Yu Lin, Hsinchu (TW); Yu-Lun Liu, Hsinchu City (TW)

(73) Assignee: NVIDIA Corp., Santa Clara, CA (US)

(21) Appl. No.: 19/543,594

(22) Filed: Feb. 18, 2026

Related U.S. Application Data
(60) Provisional application No. 63/760,056, filed on Feb. 18, 2025.

(51) Int. Cl. G06T 15/08; G06N 3/0475; G06T 5/30; G06T 5/70; G06T 5/77; G06T 7/10; G06T 7/50; G06T 15/20; G06V 10/25

(52) U.S. Cl. CPC G06T 15/08; G06N 3/0475; G06T 5/30; G06T 5/70; G06T 5/77; G06T 7/10; G06T 7/50; G06T 15/20; G06V 10/25; G06T 2207/20182

(57) ABSTRACT

Mechanisms to process multi-view RGB images and object masks into an inpainted Gaussian representation with removed objects, wherein occluded regions are consistently inpainted across views. A diffusion model trained with object masks in operated to remove objects from the scene and refined unseen mask generation, depth-aware Gaussian initialization, and SDEdit-like RGB detail enhancement are performed to produce the final rendered views.

### CROSS-REFERENCE TO RELATED APPLICATIONS

This application claims priority and benefit under 35 USC 119 (e) to U.S. application Ser. No. 63/760,056, “AuraFusion360: Augmented Unseen Region Alignment for Reference-based 360° Unbounded Scene Inpainting”, filed on Feb. 18, 2025, the contents of which are incorporated herein by reference in their entirety.

### BACKGROUND

Three-dimensional scene reconstruction and manipulation utilizing Neural Radiance Fields (NeRFs) and their extensions are important for applications such as virtual reality, augmented reality, robotics, and autonomous driving. One challenge to implementing three-dimensional scene reconstruction and manipulation is in removing objects from three-dimensional (3D) scenes while realistically filling the resulting holes. Conventional reference-based inpainting in 3D scenes, especially in 360° unbounded environments, remains a challenging task involving the exploitation of multi-view information, filling never-observed areas, and maintaining consistency and geometric plausibility across views.

Conventional methods such as SPin-NeRF and GScream are tailored for forward-facing scenes and tend to underperform in 360° unbounded scenarios. Reference-based methods, such as Infusion comprise a depth completion model that struggles to accurately project the reference view back into the 3D scene, leading to fine-tuning artifacts. Gaussian Grouping often misidentifies the unseen region during mask generation, which can degrade inpainting quality.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an embodiment of a system and process for generating reference-based 360 degree unbounded scene inpainting.

FIG. 2 depicts additional aspects of a system and process for generating reference-based 360 degree unbounded scene inpainting.

FIG. 3 depicts an embodiment of a system and process for unseen mask generation using depth warping.

FIG. 4A and FIG. 4B depict a process for generating geometrically aligned depth and multiview-consistent scene reconstruction in accordance with one embodiment.

FIG. 5 depicts a parallel processing unit in accordance with one embodiment.

FIG. 6 depicts a general processing cluster in accordance with one embodiment.

FIG. 7 depicts a memory partition unit in accordance with one embodiment.

FIG. 8 depicts a streaming multiprocessor in accordance with one embodiment.

FIG. 9 depicts a processing system in accordance with one embodiment.

FIG. 10 depicts an exemplary processing system in accordance with another embodiment.

### DETAILED DESCRIPTION

Disclosed herein are mechanisms to process multi-view RGB images {Iₙ} and object masks {Mₙ}, n∈[1 . . . . N] into an inpainted Gaussian representation with removed objects. Occluded regions (unseen regions) are consistently inpainted across views. The mechanisms comprises training a diffusion model with object masks, removing objects, and applying
(a) Refined unseen mask generation,
(b) Depth-aware Gaussian initialization, and
(c) SDEdit-like RGB detail enhancement

The disclosed mechanisms help ensure consistent texture propagation in unbounded scenes, achieving high-quality three-dimensional (3D) inpainting.

Conventional inpainting mechanisms, such as SPin-NeRF and GScream, are tailored for forward-facing scenes and tend to underperform in 360° unbounded scenarios. Reference-based methods, such as Infusion comprise depth completion models that struggle to accurately project the reference view back into the 3D scene, leading to fine-tuning artifacts. The conventional process of Gaussian grouping often misidentifies the unseen region during mask generation, which may degrade inpainting quality.

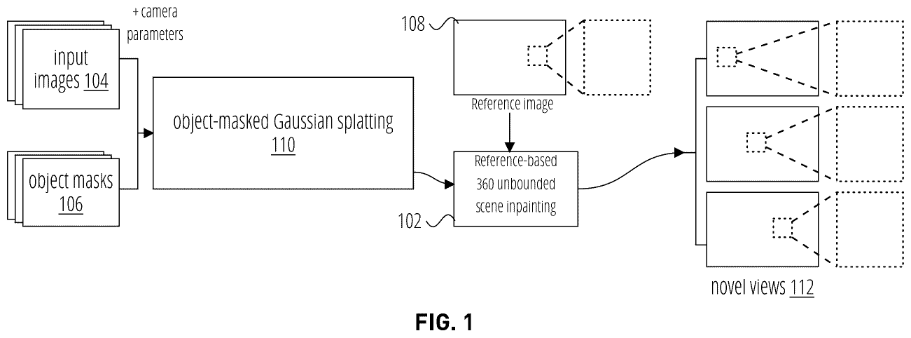

FIG. 1 depicts an embodiment of a system and process for generating reference-based 360 degree unbounded scene inpainting 102. Given input images 104 with camera parameters, object masks 106, and a reference image 108, the system generates a 3D scene in an object-masked Gaussian splatting 110 representation. The object-masked Gaussian splatting 110 representation may then be utilized to render novel views 112 of the inpainted scene, effectively removing the masked objects and inpainting unseen regions while maintaining consistency with the reference image 108.

The system exploits multi-view information and applies generative processes to fill unseen areas, helping to ensure that inpainted regions are coherent, plausible, and consistent across views, effectively removing the masked objects and restoring a realistic background in their place, while maintaining consistency with the reference image 108. Combining Gaussian splatting's multi-view consistency with 2D inpainting models' generative power addresses challenges of view consistency and 3D geometry, especially for significant view changes.

The reference-based 360 degree unbounded scene inpainting 102 may achieve a more accurate unseen mask and enhanced depth alignment through Adaptive Guided Depth Diffusion (AGDD) with an SDEdit-like process applied to leverage diffusion priors while also maintaining multiview consistency using red-green-blue (RGB) guidance. In other words, the reference-based 360 degree unbounded scene inpainting 102 provides a mechanism for generating or refining unseen masks using a diffusion model, guided by RGB (or other) image encodings, while keeping multiple camera views geometrically consistent for 3D rendering.

SDEdit is a diffusion technique known in the art, that begins with an existing signal (not pure noise). Controlled noise is added and denoising proceeds using the diffusion model. Instead of generating unseen maps from scratch, the reference-based 360 degree unbounded scene inpainting 102 starts from initial estimates, perturbs them with noise, and applies the diffusion process to refine the initial estimates with depth alignment. This process preserves structure from the inputs while benefiting from learned diffusion priors. The diffusion priors are learned during training of the diffusion model, and may include such features as what realistic outputs should look like, how geometry tends to behave, and how surfaces tend to be shaped.

When processing multiple camera views of the same scene, the corresponding unseen masks should be consistent geometrically. For example, a point unseen in view A should photo-realistically match the same point in view B after projection. Enforcing multiview consistency helps ensure that there are not inpainting contradictions across camera angles.

The diffusion model may utilize RGB guidance for color, texture, edges, and shading cues to guide the inpainting generation.

In sum, the reference-based 360 degree unbounded scene inpainting 102 starts with rough object masks, adds noise, and performs inpainting with depth alignment using a diffusion model (e.g., SDEdit). RGB images are applied to guide the process. Learned diffusion priors improve the realism of the resulting outputs. The reference-based 360 degree unbounded scene inpainting 102 is enforces consistency of inpainting across multiple camera views.

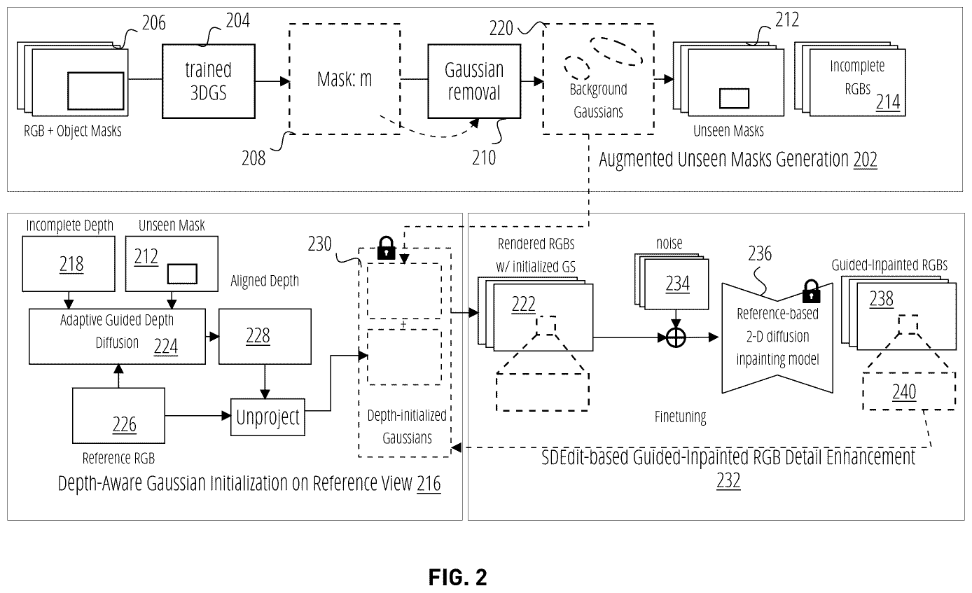

FIG. 2 depicts additional aspects of a system and process for generating reference-based 360 degree unbounded scene inpainting. During Augmented Unseen Masks Generation 202, a 3DGS 204 (3D Gaussian Splatting model) trained on object masks is operated on multi-view RGB images 206 {Iₙ} and object masks {Mₙ}, n∈[1 . . . . N] to identify Gaussians in a mask region 208. Gaussian removal 210 of objects in the mask region 208 results in unseen masks 212 in a Gaussian representation corresponding to incomplete images 214.

Depth-Aware Gaussian Initialization 216 (DAGI) is then performed to transform incomplete depth maps 218, the unseen masks 212, and the background Gaussians 220 (those Gaussians not located in the masked mask region 208) into rough rendered images 222. This is accomplished using Adaptive Guided Depth Diffusion 224 and a reference image 226 to produce an aligned depth map 228, which is applied to unproject the reference image 226 into the depth initialized Gaussians 230 used to render the rough rendered images 222.

SDEdit-based Guided-Inpainting 232 and detail enhancement is then performed by injecting adaptive injected noise 234 iteratively through a diffusion model 236, yielding a final set of inpainted images 238 comprising inpainted unseen regions 240 that may be formed into a 3D scene reconstruction.

Accurate identification of unseen regions can be critical for scene consistency and optimal use of background information. To generate the unseen mask for a view, the system differentiates between background visible across multiple views and unseen regions occluded in all views.

The system may employ depth warping to generate bounding box prompts to a segmentation model for each view to facilitate accurate, automated unseen region detection.

For each view n, the system may determine:

$${R}_{i \to n} = {W}_{traverse} ( {R}_{i} , {D}_{n}^{incomplete} , {T}_{n \to i} ) \qquad ( 1 )$$

where Wₜᵣₐᵥₑᵣₛₑ includes forward warping from view n to i and backward traversal to map the removal region back to n. Rᵢ is the removal region mask for view i, derived from depth differences.

$${D}_{n}^{incomplete}$$

is the incomplete depth map for view n, and T_{n→i} is the transformation from view n to i. The unseen mask contour for view n is obtained by aggregating warped removal regions and applying thresholding:

$${C}_{n} = θ ( \frac{1}{K} {\sum }_{i = 1}^{k} {R}_{i \to n} ) ∩ {R}_{n} \qquad ( 2 )$$

where Cₙ is the contour of the unseen mask, K is the number of views, and θ(·) is a thresholding function. A bounding box bbox (Cₙ) is created as a prompt for the segmenting model (e.g., Segment Anything Model v2, i.e., SAM2) to generate the final unseen mask:

$${U}_{n} = SAM 2 ( bbox ( {C}_{n} ) ) \qquad ( 3 )$$

This mask Uₙ guides the inpainting process, focusing on areas needing reconstruction while preserving original scene information.

To obtain the unseen mask for view n, the system may determine the pixel correspondences between the view n and all other views i by using the rendered incomplete depth

$${D}_{n}^{incomplete} .$$

For each view i, the removal region Rᵢ is backward projected to view n to align occlusions. Results from multiple views are aggregated, averaging and applying a threshold to produce the initial contour of the unseen mask. This contour may be subsequently converted into the bounding box prompt for the segmenting model that refines the unseen mask to its final version for view n.

After performing object removal and generating the unseen mask, a reference view V_{ref} may be selected that can render an incomplete RGB image and depth. RGB inpainting may be applied to the incomplete RGB image of V_{ref}, denoted by I_{ref}. To improve cross-view consistency, the reference RGB image is projected into 3D space using the depth estimates of I_{ref} obtained through Adaptive Guided Depth Diffusion. The 3D projection serves to guide the SDEdit-based RGB detail enhancement and initializes point positions for Gaussian fine-tuning. The accuracy of depth alignment determines the precision of the initial point positions.

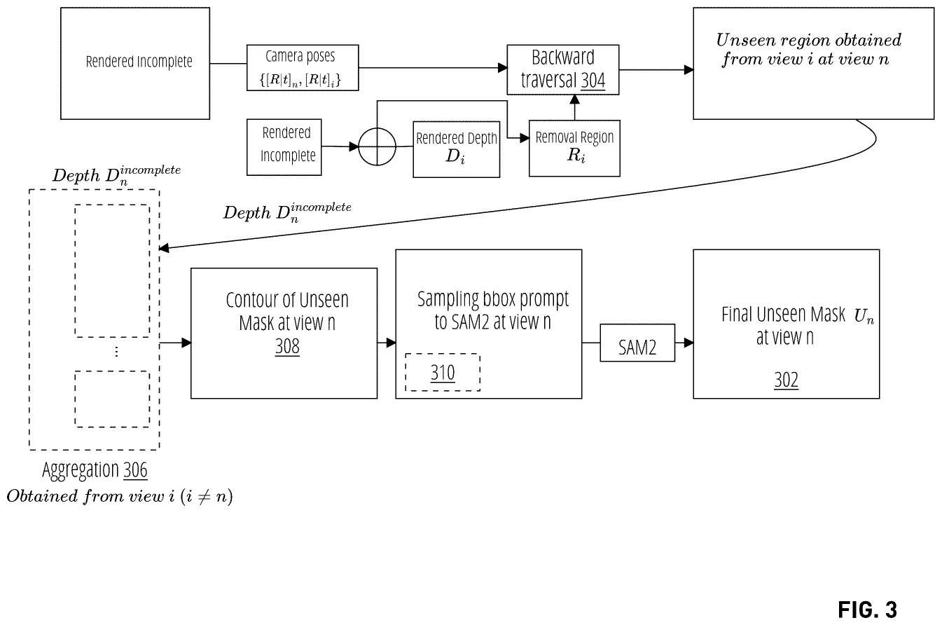

FIG. 3 depicts an embodiment of a system and process for unseen mask generation using depth warping. To obtain the unseen mask 302 for view n, the pixel correspondences between the view n and all other views i is determined by using the rendered incomplete depth

$${D}_{n}^{incomplete} .$$

For each view t, the removal region Ri undergoes backward traversal 304 to view n to align occlusions. Results from the multiple views undergo aggregation 306, averaging and applying a threshold to produce the initial unseen mask contour 308. This contour is subsequently converted into a bounding box prompt 310 for the segmentation model. This refines the rough unseen mask to the final unseen mask 302 for view n.

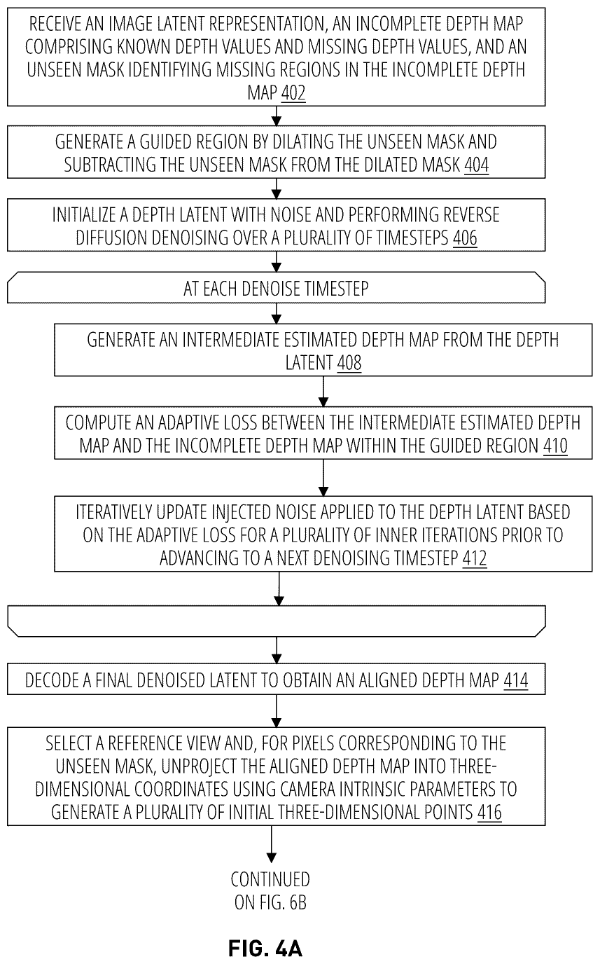

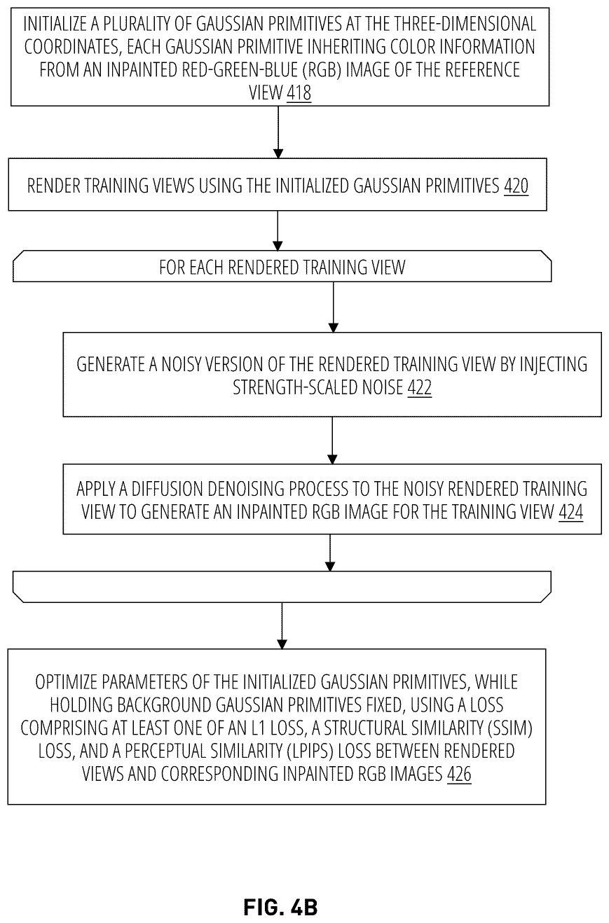

FIG. 4A and FIG. 4B depict a computer-implemented process for generating geometrically aligned depth and multiview-consistent scene reconstruction. The process begin with an image latent representation, an incomplete depth map comprising known depth values and missing depth values, and an unseen mask identifying missing regions in the incomplete depth map (block 402). A guided region is identified by dilating the unseen mask and subtracting the unseen mask from the dilated mask (block 404).

A depth latent is initialized with noise and undergoes reverse diffusion denoising over a plurality of timesteps (block 406). At each denoising timestep, an intermediate estimated depth map is generated from the depth latent (block 408), computing an adaptive loss between the intermediate estimated depth map and the incomplete depth map within the guided region (block 410), and iteratively updating injected noise applied to the depth latent based on the adaptive loss for a plurality of inner iterations prior to advancing to a next denoising timestep (block 412).

The final denoised latent is decoded to obtain an aligned depth map (block 414). A reference view is selected and, for pixels corresponding to the unseen mask, unprojecting the aligned depth map is unprojected into three-dimensional coordinates using camera intrinsic parameters to generate a plurality of initial three-dimensional points (block 416).

A plurality of Gaussian primitives are initialized at the three-dimensional coordinates, each Gaussian primitive inheriting color information from an inpainted red-green-blue (RGB) image of the reference view (block 418).

Training views are rendered using the initialized Gaussian primitives (block 420). For each rendered training view, a noisy version of the rendered training view is generated by injecting strength-scaled noise (block 422) and a diffusion denoising process is applied to the noisy rendered training view to generate an inpainted RGB image for the training view (block 424).

Parameters of the initialized Gaussian primitives are optimized while maintaining background Gaussian primitives fixed, using a loss comprising for example one or more of an L1 loss, a structural similarity (SSIM) loss, and a perceptual similarity (LPIPS) loss between rendered views and corresponding inpainted RGB images (block 426).

The AGDD process refines incomplete depth values via diffusion while coercing the depth values to match known depth near occluded regions. The aligned depth is applied to seed 3D Gaussians, generate multiview-consistent RGB inpainting via SDEdit-style diffusion, and finally optimize only the new 3D Gaussians to match those inpainted views.

The input image latent may be a latent feature representation of an RGB image generated by a VAE/diffusion pipeline. The rought/incomplete depth map may comprise a table, matrix, or other structure defining known depths for some pixels but comprising missing/unknown depths for others. The unseen mask defines pixels that correspond to “removed” or “unobserved” regions to reconstruct via inpainting. AGDD is configured with a goal of producing completed and aligned depth estimates that are consistent with the known pixel depths and accurate estimates where pixel depths are not known in advance.

The guiding region for estimation may not comprise only the missing pixels, but may also comprise a band or region around them. This is accomplished by dilation of the unseen mask to expand the mask outward to include nearby pixels, then subtraction of the original mask, i.e., M_{guided}=dilate(Mᵤₙₛₑₑₙ)−Mᵤₙₛₑₑₙ.

Depth alignment near the boundary is important for inpainting accuracy. If the boundary depth is inaccurate, the inpainted region may not blend geometrically with the rest of the scene.

The depth latent do may be generated by diffusion denoising:
Start from noisy latent d_{T}
Run denoiser steps T→ . . . →0
Final latent is d0, which may be decoded into a depth map.

The utilized diffusion model should thus generate an output that is a depth latent, not an RGB image.

At each denoising timestep, the predicted depth is compared to the known incomplete depth. At a given intermediate timestep t, the model's current estimate is still noisy and comprises a depth prediction in latent form before decoding. Let Dₜ₋₁ be the “pre-decoded” or intermediate predicted depth at a given denoising timestep. Dₜ₋₁ is compared to D_{incomplete} only within the guidance band.

The adaptive loss L_{adaptive}=loss(Dₜ₋₁, D_{incomplete}) is restricted to the guided region for a metric of how well does the predicted depth matches the actual depth near the missing boundary at each denoising step. The adaptive loss is applied to update the noise ((e.g., gradient step: ε←ε−η*∇εL_{adaptive}) being injected at the next denoising iteration. The noise input is thereby updated to urge the next denoiser output toward better depth alignment. This process may be repeated several times at each denoising timestep t before advancing to timestep t−1. The diffusion process is thereby steered so that its depth output agrees with the known incomplete depth especially in the guided ring, which is where depth alignment is most impactful.

Forming a bounding box around the unseen region limits where the guidance is applied, focusing compute power and avoiding over-constraining of unrelated areas. Depth errors far away from the unseen regions may less important for the near-boundary alignment, and so far (deeper) depth estimates may often be noisier. Threshold/weighting values may be configured so that large depth values contribute less to L_{adaptive}. The net effect is that the guidance concentrates on getting depth estimates correct where it is most impactful for the inpainted region to render realistically and accurately in 3D.

Completion of of process timesteps T→0 yields depth latent d0. Decoding this latent produces the aligned depth map: D_{aligned}=Decoder (d0). The aligned depth map is plausible under diffusion priors and aligned to the known depth near the missing regions.

A reference camera view is selected (or in some embodiments, generated) to seed new 3D geometry (Gaussians) for filling the missing areas. Pixels in the unseen mask are unprojected into 3D using the determined aligned depths. Specifically, for pixels in the unseen region of the reference view: with pixel (u, v) use depth D_{aligned} (u, v) and camera intrinsics (focal length, principal point, etc.) to unproject into 3D coordinates, resulting in a set of 3D points corresponding to the reconstructed region.

Each 3D point is then encoded into a 3D Gaussian splatting representation, with a position set according to coordinates from the unprojection of the point into 3D, a color sampled from the reference inpainted RGB at that pixel, and (in some embodiments) other characteristics such as size/opacity/orientation initialized with default values.

Existing background Gaussians remain fixed (for regions unaffected by removal) and only the newly created Gaussians are configured to move/update initially. This provides the optimizer with a reasonable starting 3D representation of the missing area.

Given current Gaussians (including new ones), the scene is rendered from multiple camera views. However the missing regions may still require RGB supervision across views. The diffusion inpainting model, guided by the reference, is thus used to generate RGB targets. The reference-guided diffusion model produce inpainted RGB in the removed regions.

If each view is inpainted independently, the results won't match across views. Thus, an SDEdit-like initialization is applied to maintain multiview consistency (especially for far away points). Instead of starting diffusion from pure noise for each view, diffusion is initialized from a rendered image (based on current 3D Gaussians/projected points), with noise added and modulated with a strength parameter. Denoising then generates the inpainted result

Each view's diffusion is “anchored” to what the current 3D geometry indicates should be there. That improves consistency between views because they're all derived from the same underlying 3D estimate.

The inpainted RGB images may then be applied as supervision signals with the diffusion outputs utilized as pseudo-ground-truth targets for the missing regions in each view.

Parameters of the newly initialized Gaussians (positions, colors, opacities, etc.) are updated while maintaining the unaffected background Gaussians fixed.

Optimization may utilize a blend of standard image losses, such as:
L1 (pixel-wise absolute difference)
SSIM (structure similarity—encourages correct local structure)
LPIPS (perceptual similarity—encourages perceptually plausible details)

The end result is a 3D Gaussian representation consistent with the multiview inpainted RGB targets, which may then be “spatted” to produce a final inpainted 3D scene.

Listing 1 depicts logic for the overall process.

Listing 1

| | |
|---|---|
| I_latent | # input image latent |
| D_incomplete | # incomplete depth map |
| M_unseen | # unseen mask (binary) |
| CameraParams | # intrinsics (focal length, principal point, etc.) |
| RefView | # selected reference view |
| θ_denoiser | # diffusion denoiser parameters |
| Decoder | # VAE decoder for depth |
| T | # number of diffusion timesteps |
| K | # number of inner adaptive iterations per timestep |
| η | # adaptive step size |

```
#Part A - Adaptive Guided Depth Diffusion (AGDD)
#Step 1: Define guided region
M_dilated = Dilate(M_unseen)
M_guided = M_dilated − M_unseen
#Optionally restrict guidance to bounding box around unseen
region.
# Step 2: Initialize diffusion
ε_T ~ N(0, I)
# initial Gaussian noise d_T = ε_T
# initial latent Step 3: Reverse diffusion with adaptive
guidance
for t = T down to 1:
  ε = ε_t
  # Inner adaptive optimization loop
    for k = 1 to K:
      d_t = Denoise(d_t, t, θ_denoiser)
      # Pre-decode depth estimate at this step
      D_t = Decoder(d_t)
      # Compute adaptive loss only in guided region
        L_adaptive = Loss( D_t[M_guided],
```

```
  D_incomplete[M_guided],
  weight_by_depth_threshold )
```

```
      # Update noise to better align depth
      ε = ε − η * ∇_ε L_adaptive
      d_t = UpdateLatentWithNoise(ε, t)
  end for
  # Move to next timestep
  d_{t−1} = StandardDiffusionStep(d_t, t)
end for
# Step 4: Final depth decoding
d_0 = d_0
D_aligned = Decoder(d_0)
# Now D_aligned is diffusion-refined and aligned to
incomplete
# depth near the unseen region.
# Part B - Initialize New 3D Gaussians
# Step 5: Unproject unseen pixels from reference view
G_new = Ø
for each pixel (u, v) where M_unseen_(u,v) == 1:
  z = D_aligned(u, v)
  X_3D = Unproject(u, v, z, CameraParams)
  color = RGB_inpainted_ref(u, v)
  G_new.add( Gaussian(
        position = X_3D,
        color = color,
        init_scale = default,
        init_opacity = default ))
end for
#Keep background Gaussians fixed:
G_fixed = ExistingGaussians (unaffected by removal)
# Part C - Reference-Guided RGB Diffusion (SDEdit-like)
# Step 6: For each training view, generate diffusion-
supervised
# RGB for each training view V_i:
  I_render = Render(G_new ∪ G_fixed, V_i)
  # SDEdit-style initialization
    ε_i ~ N(0, I)
    I_noisy = I_render + α * ε_i
    I_inpainted_i = DiffusionDenoise(I_noisy,
guidance=RefView)
end for
# α controls noise strength (SDEdit strength parameter).
# Part D - Optimize New Gaussians
# Step 7: Fine-tune only newly initialized Gaussians
for optimization_step = 1 to N_opt:
  for each training view V_i:
      I_pred = Render(G_new ∪ G_fixed, V_i)
      L_i = λ1 * L1(I_pred, I_inpainted_i)
        + λ2 * SSIM(I_pred, I_inpainted_i)
        + λ3 * LPIPS(I_pred, I_inpainted_i)
  L_total = Σ_i L_i
  UpdateParameters(G_new, ∇ L_total)
end for
# G_fixed remains unchanged during optimization.
# Final Output
Return D_aligned, Optimized Gaussians G_new ∪ G_fixed
```

The estimated depth D_{aligned}=Decoder (d₀) may be generated from a VAE decoder, where the latent d₀ is obtained by recursive denoising step dₜ₋₁=Denoise(dₜ, t, êₜ). The êₜ may be obtained by updating the noise from a prior iteration with adaptive loss L_{adaptive}. This adaptive loss refines êₜ to ensure that the estimated depth aligns with the existing incomplete depth. The depth optimization process may be represented by:

$${d}_{t - 1} = Denoise ( {d}_{t} , t , {\hat{∈}}_{t} ) \qquad ( 4 )$$

$${\hat{∈}}_{t} + UNET ( {d}_{t} , {I}_{scene} , t ) - α \cdot ∇ {ℒ}_{adaptive} \qquad ( 5 )$$

where Unet represents the diffusion model and a is the learning rate for the optimization. A bounding box B may be formed around the unseen region with a threshold δ configured to downweight errors for distant points. The adaptive loss L_{adaptive} may then be determined as follows:

$${M}_{guide} ( x , y ) = \{ \begin{matrix}1 & if ( x , y ) ∈ B \backslash U \\ 0 & otherwise\end{matrix} \qquad ( 6 )$$

$${ℒ}_{adaptive} = {\sum }_{( x , y )} {M}_{guide} ( x , y ) \cdot ℒ ( {D}_{t - 1} , {D}_{incomplete} ) ( x , y ) \qquad ( 7 )$$

$$ℒ ( {d}_{1} , {d}_{2} ) = \{ \begin{matrix}\frac{1}{2} {( {d}_{1} - {d}_{2} )}^{2} & if \vert {d}_{1} - {d}_{2} \vert < δ \\ δ \cdot \vert {d}_{1} - {d}_{2} \vert - \frac{1}{2} {δ}^{2} & otherwise\end{matrix} \qquad ( 8 )$$

where M_{guide}(x, y) is a mask function indicating if a pixel (x, y) is within the bounding box B but not within the unseen mask U. At each denoising time step, the injected noise may be updated over a number (e.g., 8) iterations. The loss ensures that the updated noise input to the denoiser enables it to generate an estimated depth that aligns with the incomplete guided depth, allowing the AGDD output to focus on accurate alignment in the region near the unseen area.

New Gaussians in the unseen regions may be initialized using the aligned depth D_{refaligned} of the reference view. First, the inpainted RGB of the reference view is unprojected with

$${D}_{aligned}^{ref}$$

3D space, focusing on the unseen regions identified by the unseen mask. This unprojection may take into account the camera's intrinsic parameters. For each pixel (u, v) in the unseen region where U_{final}(u, v)=1, compute the 3D point P=(X, Y, Z) as

$$Z = {D}_{aligned}^{ref} ( u , v ) , X = ( u - {c}_{x} ) \cdot Z / {f}_{x} , Y = ( v - {c}_{y} ) \cdot Z / {f}_{y} ,$$

where (fₓ, f_{y}) are the focal lengths in pixels and (cₓ, c_{y}) are the principal point offsets.

This process yields a set of initial 3D points P. These points may then be applied to initialize new Gaussians in the unseen regions, inheriting color from the reference view. Existing background Gaussians, unaffected by object removal, remain fixed during initialization and optimization. These initialized Gaussians are utilized in the subsequent process of generating guided inpainting and optimization.

After initializing the Gaussians to fill unseen regions, a reference-guided diffusion model (e.g., Left-Refill) may be operated for RGB inpainting of the removed regions. To maintain consistency across views, especially in areas far from the camera, SDEdit-like diffusion may be used to leverage the initial 3D-projected points. Instead of denoising from pure noise, a strength-scaled noise may be added to each rendered training view:

$${I}_{guided} = Denoise ( {I}_{init} + ∈ \cdot s , t ( s ) \to 0 ) \qquad ( 9 )$$

where s controls noise strength and t(s) is the initial timestep. The resulting inpainted RGB images supervise Gaussian fine-tuning, updating only the unprojected Gaussians. Optimization may then be performed using a combination of L1, SSIM, and LPIPS losses:

$$ℒ = ( 1 - {λ}_{SSIM} ) {ℒ}_{1} + {λ}_{SSIM} {ℒ}_{SSIM} + {λ}_{LPIPS} {ℒ}_{LPIPS} . \qquad ( 10 )$$

The mechanisms disclosed herein may be implemented in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary architectures will now be described that may be configured to implement the mechanisms disclosed herein, for example with machine-readable instructions stored in a non-volatile machine-readable media (e.g., memory 502, main memory 1002), that configure one or more computer system comprising a data processor (e.g., parallel processing unit 504, parallel processing module 902, central processing unit 904 . . . ) to implement the disclosed mechanisms.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

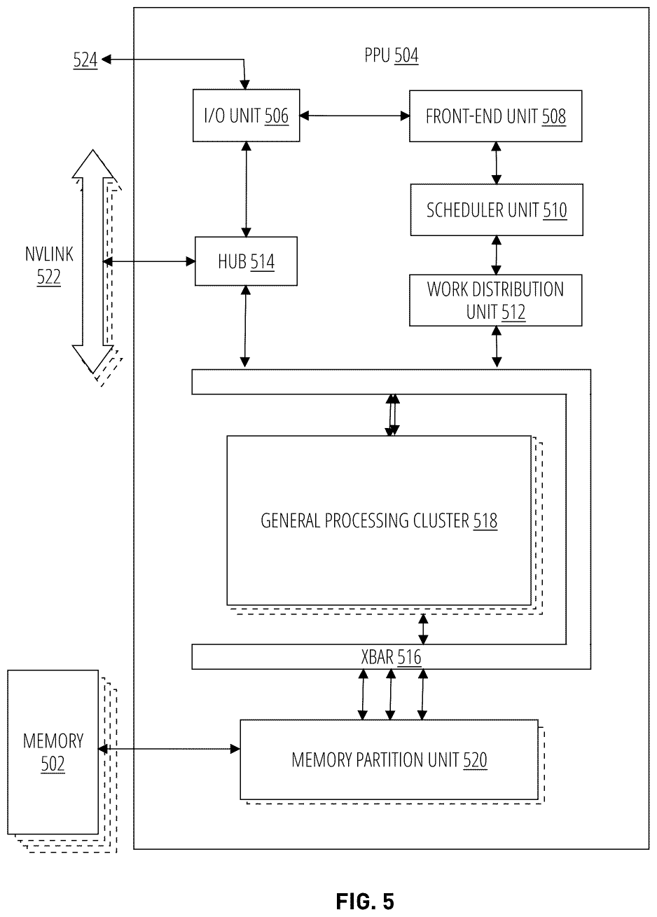

FIG. 5 depicts a parallel processing unit 504, in accordance with an embodiment. In an embodiment, the parallel processing unit 504 is a multi-threaded processor that is implemented on one or more integrated circuit devices. The parallel processing unit 504 is a latency hiding architecture designed to process many threads in parallel. A thread (e.g., a thread of execution) is an instantiation of a set of instructions configured to be executed by the parallel processing unit 504. In an embodiment, the parallel processing unit 504 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 504 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 504 modules may be configured to accelerate thousands of High Performance Computing (HPC), data center, and machine learning applications. The parallel processing unit 504 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 5, the parallel processing unit 504 includes an I/O unit 506, a front-end unit 508, a scheduler unit 510, a work distribution unit 512, a hub 514, a crossbar 516, one or more general processing cluster 518 modules, and one or more memory partition unit 520 modules. The parallel processing unit 504 may be connected to a host processor or other parallel processing unit 504 modules via one or more high-speed NVLink 522 interconnects. The parallel processing unit 504 may be connected to a host processor or other peripheral devices via an interconnect 524. The parallel processing unit 504 may also be connected to a local memory comprising a number of memory 502 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 502 may comprise logic to configure the parallel processing unit 504 to carry out aspects of the techniques disclosed herein.

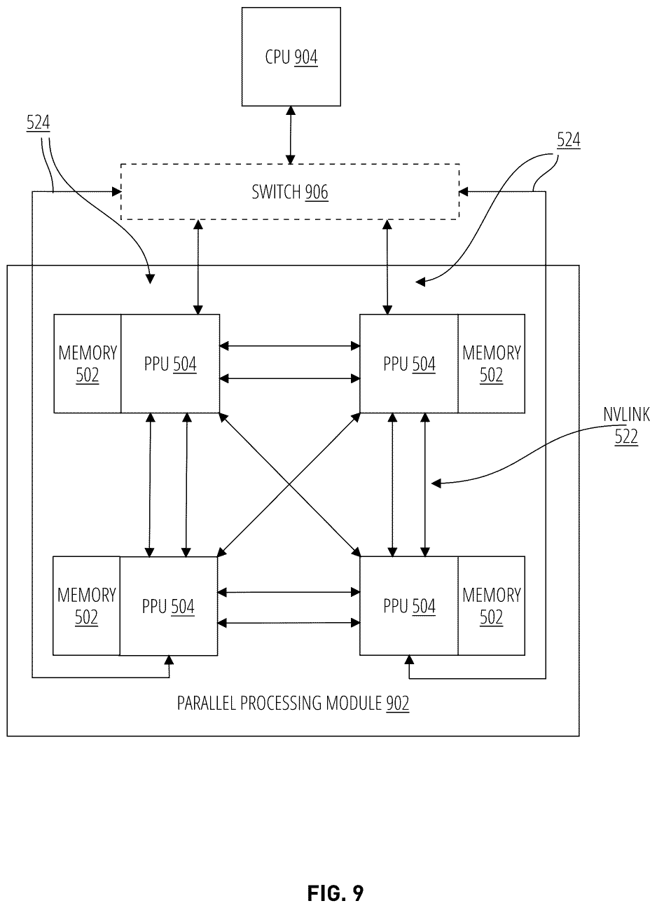

The NVLink 522 interconnect enables systems to scale and include one or more parallel processing unit 504 modules combined with one or more CPUs, supports cache coherence between the parallel processing unit 504 modules and CPUs, and CPU mastering. Data and/or commands may be transmitted by the NVLink 522 through the hub 514 to/from other units of the parallel processing unit 504 such as one or more copy engines, a video encoder, a video decoder, a power management unit, etc. (not explicitly shown). The NVLink 522 is described in more detail in conjunction with FIG. 9.

The I/O unit 506 is configured to transmit and receive communications (e.g., commands, data, etc.) from a host processor (not shown) over the interconnect 524. The I/O unit 506 may communicate with the host processor directly via the interconnect 524 or through one or more intermediate devices such as a memory bridge. In an embodiment, the I/O unit 506 may communicate with one or more other processors, such as one or more parallel processing unit 504 modules via the interconnect 524. In an embodiment, the I/O unit 506 implements a Peripheral Component Interconnect Express (PCIe) interface for communications over a PCIe bus and the interconnect 524 is a PCIe bus. In alternative embodiments, the I/O unit 506 may implement other types of well-known interfaces for communicating with external devices.

The I/O unit 506 decodes packets received via the interconnect 524. In an embodiment, the packets represent commands configured to cause the parallel processing unit 504 to perform various operations. The I/O unit 506 transmits the decoded commands to various other units of the parallel processing unit 504 as the commands may specify. For example, some commands may be transmitted to the front-end unit 508. Other commands may be transmitted to the hub 514 or other units of the parallel processing unit 504 such as one or more copy engines, a video encoder, a video decoder, a power management unit, etc. (not explicitly shown). In other words, the I/O unit 506 is configured to route communications between and among the various logical units of the parallel processing unit 504.

In an embodiment, a program executed by the host processor encodes a command stream in a buffer that provides workloads to the parallel processing unit 504 for processing. A workload may comprise several instructions and data to be processed by those instructions. The buffer is a region in a memory that is accessible (e.g., read/write) by both the host processor and the parallel processing unit 504. For example, the I/O unit 506 may be configured to access the buffer in a system memory connected to the interconnect 524 via memory requests transmitted over the interconnect 524. In an embodiment, the host processor writes the command stream to the buffer and then transmits a pointer to the start of the command stream to the parallel processing unit 504. The front-end unit 508 receives pointers to one or more command streams. The front-end unit 508 manages the one or more streams, reading commands from the streams and forwarding commands to the various units of the parallel processing unit 504.

The front-end unit 508 is coupled to a scheduler unit 510 that configures the various general processing cluster 518 modules to process tasks defined by the one or more streams. The scheduler unit 510 is configured to track state information related to the various tasks managed by the scheduler unit 510. The state may indicate which general processing cluster 518 a task is assigned to, whether the task is active or inactive, a priority level associated with the task, and so forth. The scheduler unit 510 manages the execution of a plurality of tasks on the one or more general processing cluster 518 modules.

The scheduler unit 510 is coupled to a work distribution unit 512 that is configured to dispatch tasks for execution on the general processing cluster 518 modules. The work distribution unit 512 may track a number of scheduled tasks received from the scheduler unit 510. In an embodiment, the work distribution unit 512 manages a pending task pool and an active task pool for each of the general processing cluster 518 modules. The pending task pool may comprise a number of slots (e.g., 32 slots) that contain tasks assigned to be processed by a particular general processing cluster 518. The active task pool may comprise a number of slots (e.g., 4 slots) for tasks that are actively being processed by the general processing cluster 518 modules. As a general processing cluster 518 finishes the execution of a task, that task is evicted from the active task pool for the general processing cluster 518 and one of the other tasks from the pending task pool is selected and scheduled for execution on the general processing cluster 518. If an active task has been idle on the general processing cluster 518, such as while waiting for a data dependency to be resolved, then the active task may be evicted from the general processing cluster 518 and returned to the pending task pool while another task in the pending task pool is selected and scheduled for execution on the general processing cluster 518.

The work distribution unit 512 communicates with the one or more general processing cluster 518 modules via crossbar 516. The crossbar 516 is an interconnect network that couples many of the units of the parallel processing unit 504 to other units of the parallel processing unit 504. For example, the crossbar 516 may be configured to couple the work distribution unit 512 to a particular general processing cluster 518. Although not shown explicitly, one or more other units of the parallel processing unit 504 may also be connected to the crossbar 516 via the hub 514.

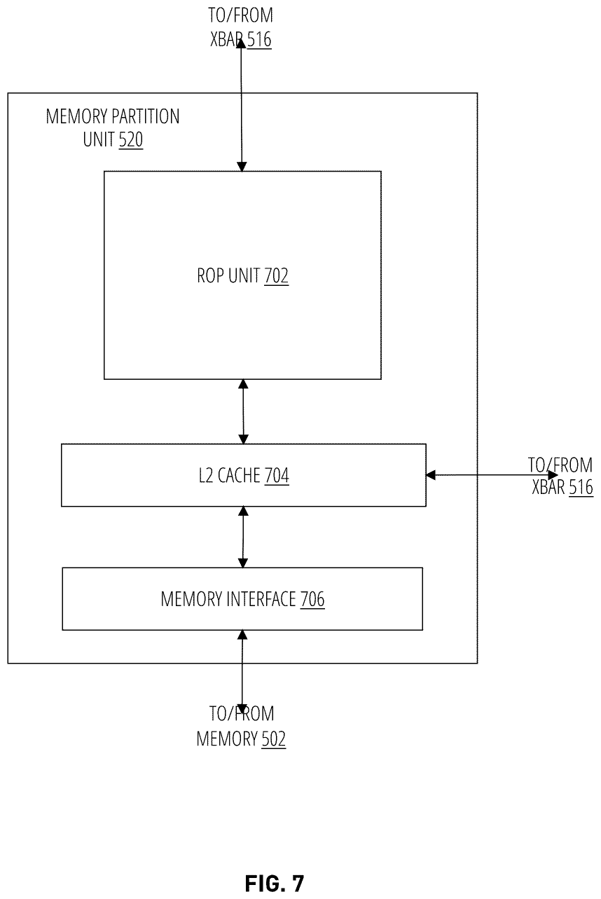

The tasks are managed by the scheduler unit 510 and dispatched to a general processing cluster 518 by the work distribution unit 512. The general processing cluster 518 is configured to process the task and generate results. The results may be consumed by other tasks within the general processing cluster 518, routed to a different general processing cluster 518 via the crossbar 516, or stored in the memory 502. The results can be written to the memory 502 via the memory partition unit 520 modules, which implement a memory interface for reading and writing data to/from the memory 502. The results can be transmitted to another parallel processing unit 504 or CPU via the NVLink 522. In an embodiment, the parallel processing unit 504 includes a number U of memory partition unit 520 modules that is equal to the number of separate and distinct memory 502 devices coupled to the parallel processing unit 504. A memory partition unit 520 will be described in more detail below in conjunction with FIG. 7.

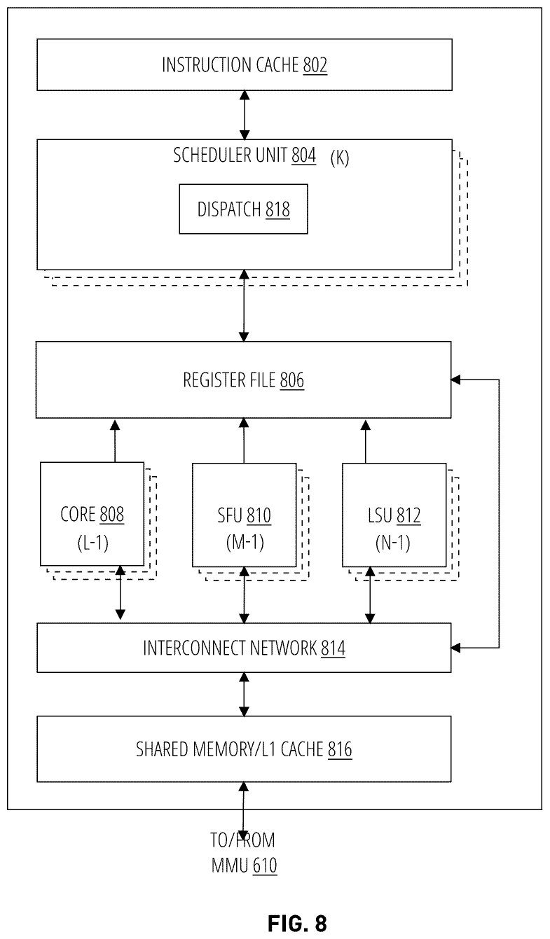

In an embodiment, a host processor executes a driver kernel that implements an application programming interface (API) that enables one or more applications executing on the host processor to schedule operations for execution on the parallel processing unit 504. In an embodiment, multiple compute applications are simultaneously executed by the parallel processing unit 504 and the parallel processing unit 504 provides isolation, quality of service (QoS), and independent address spaces for the multiple compute applications. An application may generate instructions (e.g., API calls) that cause the driver kernel to generate one or more tasks for execution by the parallel processing unit 504. The driver kernel outputs tasks to one or more streams being processed by the parallel processing unit 504. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 8.

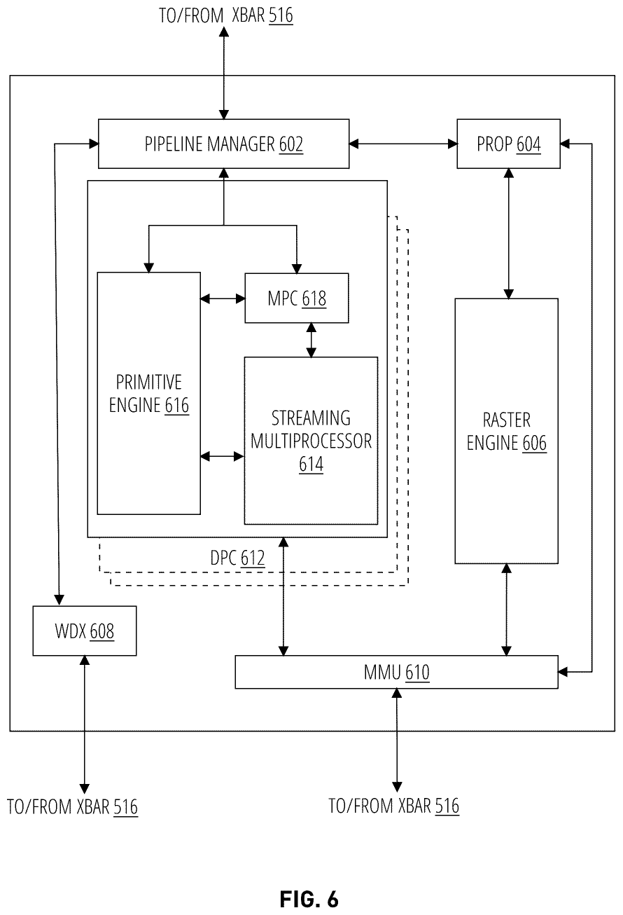

FIG. 6 depicts a general processing cluster 518 of the parallel processing unit 504 of FIG. 5, in accordance with an embodiment. As shown in FIG. 6, each general processing cluster 518 includes a number of hardware units for processing tasks. In an embodiment, each general processing cluster 518 includes a pipeline manager 602, a pre-raster operations unit 604, a raster engine 606, a work distribution crossbar 608, a memory management unit 610, and one or more data processing cluster 612. It will be appreciated that the general processing cluster 518 of FIG. 6 may include other hardware units in lieu of or in addition to the units shown in FIG. 6.

In an embodiment, the operation of the general processing cluster 518 is controlled by the pipeline manager 602. The pipeline manager 602 manages the configuration of the one or more data processing cluster 612 modules for processing tasks allocated to the general processing cluster 518. In an embodiment, the pipeline manager 602 may configure at least one of the one or more data processing cluster 612 modules to implement at least a portion of a graphics rendering pipeline. For example, a data processing cluster 612 may be configured to execute a vertex shader program on the programmable streaming multiprocessor 614. The pipeline manager 602 may also be configured to route packets received from the work distribution unit 512 to the appropriate logical units within the general processing cluster 518. For example, some packets may be routed to fixed function hardware units in the pre-raster operations unit 604 and/or raster engine 606 while other packets may be routed to the data processing cluster 612 modules for processing by the primitive engine 616 or the streaming multiprocessor 614. In an embodiment, the pipeline manager 602 may configure at least one of the one or more data processing cluster 612 modules to implement a neural network model and/or a computing pipeline.

The pre-raster operations unit 604 is configured to route data generated by the raster engine 606 and the data processing cluster 612 modules to a Raster Operations (ROP) unit, described in more detail in conjunction with FIG. 7. The pre-raster operations unit 604 may also be configured to perform optimizations for color blending, organize pixel data, perform address translations, and the like.

The raster engine 606 includes a number of fixed function hardware units configured to perform various raster operations. In an embodiment, the raster engine 606 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 606 comprises fragments to be processed, for example, by a fragment shader implemented within a data processing cluster 612.

Each data processing cluster 612 included in the general processing cluster 518 includes an M-pipe controller 618, a primitive engine 616, and one or more streaming multiprocessor 614 modules. The M-pipe controller 618 controls the operation of the data processing cluster 612, routing packets received from the pipeline manager 602 to the appropriate units in the data processing cluster 612. For example, packets associated with a vertex may be routed to the primitive engine 616, which is configured to fetch vertex attributes associated with the vertex from the memory 502. In contrast, packets associated with a shader program may be transmitted to the streaming multiprocessor 614.

The streaming multiprocessor 614 comprises a programmable streaming processor that is configured to process tasks represented by a number of threads. Each streaming multiprocessor 614 is multi-threaded and configured to execute a plurality of threads (e.g., 32 threads) from a particular group of threads concurrently. In an embodiment, the streaming multiprocessor 614 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 614 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 614 will be described in more detail below in conjunction with FIG. 8.

The memory management unit 610 provides an interface between the general processing cluster 518 and the memory partition unit 520. The memory management unit 610 may provide translation of virtual addresses into physical addresses, memory protection, and arbitration of memory requests. In an embodiment, the memory management unit 610 provides one or more translation lookaside buffers (TLBs) for performing translation of virtual addresses into physical addresses in the memory 502.

FIG. 7 depicts a memory partition unit 520 of the parallel processing unit 504 of FIG. 5, in accordance with an embodiment. As shown in FIG. 7, the memory partition unit 520 includes a raster operations unit 702, a level two cache 704, and a memory interface 706. The memory interface 706 is coupled to the memory 502. Memory interface 706 may implement 32, 64, 128, 1024-bit data buses, or the like, for high-speed data transfer. In an embodiment, the parallel processing unit 504 incorporates U memory interface 706 modules, one memory interface 706 per pair of memory partition unit 520 modules, where each pair of memory partition unit 520 modules is connected to a corresponding memory 502 device. For example, parallel processing unit 504 may be connected to up to Y memory 502 devices, such as high bandwidth memory stacks or graphics double-data-rate, version 5, synchronous dynamic random access memory, or other types of persistent storage.

In an embodiment, the memory interface 706 implements an HBM2 memory interface and Y equals half U. In an embodiment, the HBM2 memory stacks are located on the same physical package as the parallel processing unit 504, providing substantial power and area savings compared with conventionalGDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 502 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 504 modules process very large datasets and/or run applications for extended periods.

In an embodiment, the parallel processing unit 504 implements a multi-level memory hierarchy. In an embodiment, the memory partition unit 520 supports a unified memory to provide a single unified virtual address space for CPU and parallel processing unit 504 memory, enabling data sharing between virtual memory systems. In an embodiment the frequency of accesses by a parallel processing unit 504 to memory located on other processors is traced to ensure that memory pages are moved to the physical memory of the parallel processing unit 504 that is accessing the pages more frequently. In an embodiment, the NVLink 522 supports address translation services allowing the parallel processing unit 504 to directly access a CPU's page tables and providing full access to CPU memory by the parallel processing unit 504.

In an embodiment, copy engines transfer data between multiple parallel processing unit 504 modules or between parallel processing unit 504 modules and CPUs. The copy engines can generate page faults for addresses that are not mapped into the page tables. The memory partition unit 520 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 502 or other system memory may be fetched by the memory partition unit 520 and stored in the level two cache 704, which is located on-chip and is shared between the various general processing cluster 518 modules. As shown, each memory partition unit 520 includes a portion of the level two cache 704 associated with a corresponding memory 502 device. Lower level caches may then be implemented in various units within the general processing cluster 518 modules. For example, each of the streaming multiprocessor 614 modules may implement an L1 cache. The L1 cache is private memory that is dedicated to a particular streaming multiprocessor 614. Data from the level two cache 704 may be fetched and stored in each of the L1 caches for processing in the functional units of the streaming multiprocessor 614 modules. The level two cache 704 is coupled to the memory interface 706 and the crossbar 516.

The raster operations unit 702 performs graphics raster operations related to pixel color, such as color compression, pixel blending, and the like. The raster operations unit 702 also implements depth testing in conjunction with the raster engine 606, receiving a depth for a sample location associated with a pixel fragment from the culling engine of the raster engine 606. The depth is tested against a corresponding depth in a depth buffer for a sample location associated with the fragment. If the fragment passes the depth test for the sample location, then the raster operations unit 702 updates the depth buffer and transmits a result of the depth test to the raster engine 606. It will be appreciated that the number of partition memory partition unit 520 modules may be different than the number of general processing cluster 518 modules and, therefore, each raster operations unit 702 may be coupled to each of the general processing cluster 518 modules. The raster operations unit 702 tracks packets received from the different general processing cluster 518 modules and determines which general processing cluster 1 that a result generated by the raster operations unit 702 is routed to through the crossbar 516. Although the raster operations unit 702 is included within the memory partition unit 520 in FIG. 7, in other embodiment, the raster operations unit 702 may be outside of the memory partition unit 520. For example, the raster operations unit 702 may reside in the general processing cluster 518 or another unit.

FIG. 8 illustrates the streaming multiprocessor 614 of FIG. 6, in accordance with an embodiment. As shown in FIG. 8, the streaming multiprocessor 614 includes an instruction cache 802, one or more scheduler unit 804 modules (e.g., such as scheduler unit 510), a register file 806, one or more processing core 808 modules, one or more special function unit 810 modules, one or more load/store unit 812 modules, an interconnect network 814, and a shared memory/L1 cache 816.

As described above, the work distribution unit 512 dispatches tasks for execution on the general processing cluster 518 modules of the parallel processing unit 504. The tasks are allocated to a particular data processing cluster 612 within a general processing cluster 518 and, if the task is associated with a shader program, the task may be allocated to a streaming multiprocessor 614. The scheduler unit 510 receives the tasks from the work distribution unit 512 and manages instruction scheduling for one or more thread blocks assigned to the streaming multiprocessor 614. The scheduler unit 804 schedules thread blocks for execution as warps of parallel threads, where each thread block is allocated at least one warp. In an embodiment, each warp executes 32 threads. The scheduler unit 804 may manage a plurality of different thread blocks, allocating the warps to the different thread blocks and then dispatching instructions from the plurality of different cooperative groups to the various functional units (e.g., core 808 modules, special function unit 810 modules, and load/store unit 812 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads ( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 818 unit is configured within the scheduler unit 804 to transmit instructions to one or more of the functional units. In one embodiment, the scheduler unit 804 includes two dispatch 818 units that enable two different instructions from the same warp to be dispatched during each clock cycle. In alternative embodiments, each scheduler unit 804 may include a single dispatch 818 unit or additional dispatch 818 units.

Each streaming multiprocessor 614 includes a register file 806 that provides a set of registers for the functional units of the streaming multiprocessor 614. In an embodiment, the register file 806 is divided between each of the functional units such that each functional unit is allocated a dedicated portion of the register file 806. In another embodiment, the register file 806 is divided between the different warps being executed by the streaming multiprocessor 614. The register file 806 provides temporary storage for operands connected to the data paths of the functional units.

Each streaming multiprocessor 614 comprises L processing core 808 modules. In an embodiment, the streaming multiprocessor 614 includes a large number (e.g., 128, etc.) of distinct processing core 808 modules. Each core 808 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 808 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 808 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 614 also comprises M special function unit 810 modules that perform special functions (e.g., attribute evaluation, reciprocal square root, and the like). In an embodiment, the special function unit 810 modules may include a tree traversal unit configured to traverse a hierarchical tree data structure. In an embodiment, the special function unit 810 modules may include texture unit configured to perform texture map filtering operations. In an embodiment, the texture units are configured to load texture maps (e.g., a 2D array of texels) from the memory 502 and sample the texture maps to produce sampled texture values for use in shader programs executed by the streaming multiprocessor 614. In an embodiment, the texture maps are stored in the shared memory/L1 cache 816. The texture units implement texture operations such as filtering operations using mip-maps (e.g., texture maps of varying levels of detail). In an embodiment, each streaming multiprocessor 614 includes two texture units.

Each streaming multiprocessor 614 also comprises N load/store unit 812 modules that implement load and store operations between the shared memory/L1 cache 816 and the register file 806. Each streaming multiprocessor 614 includes an interconnect network 814 that connects each of the functional units to the register file 806 and the load/store unit 812 to the register file 806 and shared memory/L1 cache 816. In an embodiment, the interconnect network 814 is a crossbar that can be configured to connect any of the functional units to any of the registers in the register file 806 and connect the load/store unit 812 modules to the register file 806 and memory locations in shared memory/L1 cache 816.

The shared memory/L1 cache 816 is an array of on-chip memory that allows for data storage and communication between the streaming multiprocessor 614 and the primitive engine 616 and between threads in the streaming multiprocessor 614. In an embodiment, the shared memory/L1 cache 816 comprises 128 KB of storage capacity and is in the path from the streaming multiprocessor 614 to the memory partition unit 520. The shared memory/L1 cache 816 can be used to cache reads and writes. One or more of the shared memory/L1 cache 816, level two cache 704, and memory 502are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 816 enables the shared memory/L1 cache 816 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 5, are bypassed, creating a much simpler programming model. In the general purpose parallel computation configuration, the work distribution unit 512 assigns and distributes blocks of threads directly to the data processing cluster 612 modules. The threads in a block execute the same program, using a unique thread ID in the calculation to ensure each thread generates unique results, using the streaming multiprocessor 614 to execute the program and perform calculations, shared memory/L1 cache 816 to communicate between threads, and the load/store unit 812 to read and write global memory through the shared memory/L1 cache 816 and the memory partition unit 520. When configured for general purpose parallel computation, the streaming multiprocessor 614 can also write commands that the scheduler unit 510 can use to launch new work on the data processing cluster 612 modules.

The parallel processing unit 504 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 504 is embodied on a single semiconductor substrate. In another embodiment, the parallel processing unit 504 is included in a system-on-a-chip (SoC) along with one or more other devices such as additional parallel processing unit 504 modules, the memory 502, a reduced instruction set computer (RISC) CPU, a memory management unit (MMU), a digital-to-analog converter (DAC), and the like.

In an embodiment, the parallel processing unit 504 may be included on a graphics card that includes one or more memory devices. The graphics card may be configured to interface with a PCIe slot on a motherboard of a desktop computer. In yet another embodiment, the parallel processing unit 504 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 9 is a conceptual diagram of a processing system implemented using the parallel processing unit 504 of FIG. 5, in accordance with an embodiment. The processing system includes a central processing unit 904, a switch 906, and multiple parallel processing unit 504 modules each and respective memory 502 modules. The switch 906 is depicted with dashed lines, indicating that it is optional in some embodiments.

The NVLink 522 provides high-speed communication links between each of the parallel processing unit 504 modules. Although a particular number of NVLink 522 and interconnect 524 connections are illustrated in FIG. 9, the number of connections to each parallel processing unit 504 and the central processing unit 904 may vary. The switch 906 interfaces between the interconnect 524 and the central processing unit 904. The parallel processing unit 504 modules, memory 502 modules, and NVLink 522 connections may be situated on a single semiconductor platform to form a parallel processing module 902. In an embodiment, the switch 906 supports two or more protocols to interface between various different connections and/or links.

In another embodiment (not shown), the NVLink 522 provides one or more high-speed communication links between each of the parallel processing unit modules (parallel processing unit 504, parallel processing unit 504, parallel processing unit 504, and parallel processing unit 504) and the central processing unit 904 and the switch 906 (when present) interfaces between the interconnect 524 and each of the parallel processing unit modules. The parallel processing unit modules, memory 502 modules, and interconnect 524 may be situated on a single semiconductor platform to form a parallel processing module 902. In yet another embodiment (not shown), the interconnect 524 provides one or more communication links between each of the parallel processing unit modules and the central processing unit 904 and the switch 906 interfaces between each of the parallel processing unit modules using the NVLink 522 to provide one or more high-speed communication links between the parallel processing unit modules. In another embodiment (not shown), the NVLink 522 provides one or more high-speed communication links between the parallel processing unit modules and the central processing unit 904 through the switch 906. In yet another embodiment (not shown), the interconnect 524 provides one or more communication links between each of the parallel processing unit modules directly. One or more of the NVLink 522 high-speed communication links may be implemented as a physical NVLink interconnect or either an on-chip or on-die interconnect using the same protocol as the NVLink 522.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 902 may be implemented as a circuit board substrate and each of the parallel processing unit modules and/or memory 502 modules may be packaged devices. In an embodiment, the central processing unit 904, switch 906, and the parallel processing module 902 are situated on a single semiconductor platform.

In an embodiment, each parallel processing unit module includes six NVLink 522 interfaces (as shown in FIG. 9, five NVLink 522 interfaces are included for each parallel processing unit module). The NVLink 522 may be operated exclusively for PPU-to-PPU communication as shown in FIG. 9, or some combination of PPU-to-PPU and PPU-to-CPU, when the central processing unit 904 also includes one or more NVLink 522 interfaces.

In an embodiment, the NVLink 522 allows direct load/store/atomic access from the central processing unit 904 to each parallel processing unit module's memory 502. In an embodiment, the NVLink 522 supports coherency operations, allowing data read from the memory 502 modules to be stored in the cache hierarchy of the central processing unit 904, reducing cache access latency for the central processing unit 904. In an embodiment, the NVLink 522 includes support for Address Translation Services (ATS), enabling the parallel processing unit module to directly access page tables within the central processing unit 904. One or more of the NVLink 522 may also be configured to operate in a low-power mode.

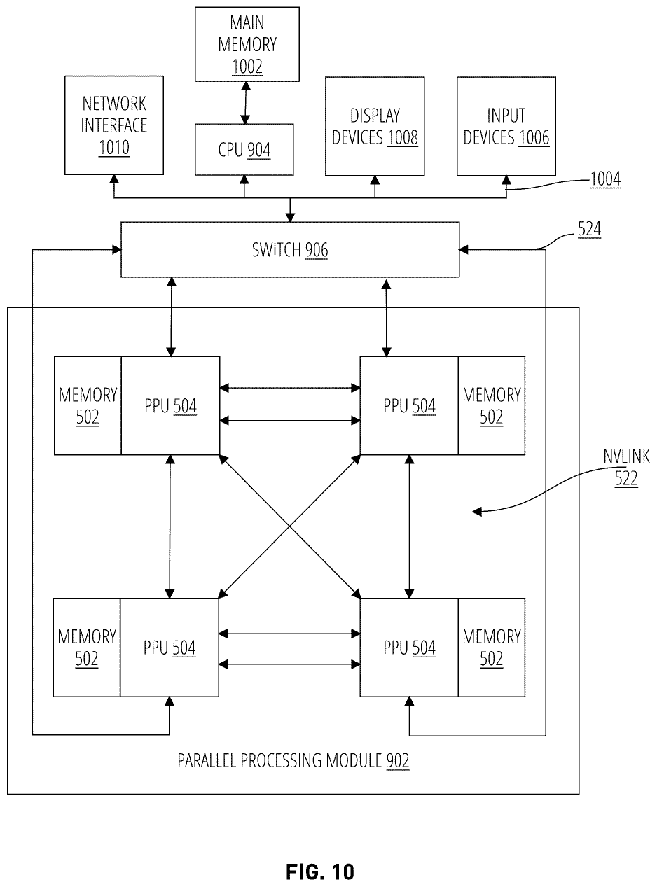

FIG. 10 depicts an exemplary processing system in which the various architecture and/or functionality of the various previous embodiments may be implemented. As shown, an exemplary processing system is provided including at least one central processing unit 904 that is connected to a communications bus 1004. The communication communications bus 1004 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1002. Control logic (software) and data are stored in the main memory 1002 which may take the form of random access memory (RAM). For simplicity of illustration, the main memory 1002 may be understood to comprise other forms of bulk memory, including non-volatile memory technologies.

The exemplary processing system also includes input devices 1006, the parallel processing module 902, and display devices 1008, e.g. a conventional CRT (cathode ray tube), LCD (liquid crystal display), LED (light emitting diode), plasma display or the like. User input may be received from the input devices 1006, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1010 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1002 and/or the secondary storage. Such computer programs, when executed, enable the exemplary processing system to perform various functions. The main memory 1002, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 reference-based 360 degree unbounded scene inpainting
104 input images
106 object masks
108 reference image
110 object-masked Gaussian splatting
112 novel views
202 Augmented Unseen Masks Generation
204 3DGS
206 input RGB views
208 mask region
210 Gaussian removal
212 unseen masks
214 incomplete images
216 Depth-Aware Gaussian Initialization
218 incomplete depth map
220 background Gaussians
222 rough rendered images
224 Adaptive Guided Depth Diffusion
226 reference image
228 aligned depth map
230 depth initialized Gaussians
232 SDEdit-based Guided-Inpainting
234 injected noise
236 diffusion model
238 inpainted images
240 inpainted unseen region
302 unseen mask
304 backward traversal
306 aggregation
308 initial unseen mask contour
310 bounding box prompt
402 block
404 block
406 block
408 block
410 block
412 block
414 block
416 block
418 block
420 block
422 block
424 block
426 block
502 memory
504 parallel processing unit
506 I/O unit
508 front-end unit
510 scheduler unit
512 work distribution unit
514 hub
516 crossbar
518 general processing cluster
520 memory partition unit
522 NVLink
524 interconnect
602 pipeline manager
604 pre-raster operations unit
606 raster engine
608 work distribution crossbar
610 memory management unit
612 data processing cluster
614 streaming multiprocessor
616 primitive engine
618 M-pipe controller
702 raster operations unit
704 level two cache
706 memory interface
802 instruction cache
804 scheduler unit
806 register file
808 core
810 special function unit
812 load/store unit
814 interconnect network
816 shared memory/L1 cache
818 dispatch
902 parallel processing module
904 central processing unit
906 switch
1002 main memory
1004 communications bus
1006 input devices
1008 display devices
1010 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A computer-implemented process for geometrically aligned depth and multiview-consistent scene reconstruction, the process comprising:
transforming an image latent representation, an incomplete depth map comprising known depth values and missing depth values, and an unseen mask identifying missing regions in the incomplete depth map to generate a set of depth initialized Gaussians;
rendering training views using the depth initialized Gaussians;
for each rendered training view:
generating a noisy version of the rendered training view by injecting noise across multiple iterations; and
applying a diffusion denoising process to the noisy version of the rendered training view to generate an inpainted image for the training view.

2. The process of claim 1, wherein transforming the image latent representation, the incomplete depth map, and the unseen mask comprises identifying a guided region by dilating the unseen mask to form a dilated mask and subtracting the unseen mask from the dilated mask.

3. The process of claim 2, wherein transforming the image latent representation, the incomplete depth map, and the unseen mask comprises initializing a depth latent with noise and performing reverse diffusion denoising over a plurality of timesteps to generate an aligned depth map.

4. The process of claim 3, wherein, at each timestep of the reverse diffusion denoising, the process further comprises:
generating an intermediate estimated depth map from the depth latent;
computing an adaptive loss between the intermediate estimated depth map and the incomplete depth map within the guided region; and
iteratively updating injected noise applied to the depth latent based on the adaptive loss for a plurality of inner iterations prior to advancing to a next timestep.

5. The process of claim 4, further comprising forming a bounding box around the unseen mask and restricting computation of the adaptive loss to pixels within the bounding box and outside the unseen mask.

6. The process of claim 4, further comprising downweighting contributions to the adaptive loss for pixels associated with depth values exceeding a configured threshold.

7. The process of claim 3, wherein the aligned depth map is generated by decoding a final denoised depth latent.

8. The process of claim 3, wherein generating the set of depth initialized Gaussians comprises selecting a reference view and unprojecting pixels of the reference view corresponding to the unseen mask into three-dimensional coordinates using camera intrinsic parameters and the aligned depth map.

9. The process of claim 8, wherein the set of depth initialized Gaussian primitives are initialized with positions determined from the three-dimensional coordinates and a color sampled from an inpainted image of the reference view.

10. The process of claim 1, wherein applying the diffusion denoising process comprises performing an SDEdit-like diffusion process in which the noisy version of the rendered training view is generated by adding strength-scaled noise to a rendered image.

11. The process of claim 10, wherein the strength-scaled noise is added according to a noise strength parameter.

12. The process of claim 1, further comprising maintaining background Gaussian primitives fixed during subsequent optimization while updating parameters of Gaussians corresponding to the unseen mask.

13. The process of claim 12, further comprising optimizing the parameters of depth initialized Gaussians corresponding to the unseen mask using a loss comprising at least one of an L1 loss, a structural similarity loss, and a perceptual similarity loss between a rendered view and the inpainted image.

14. The process of claim 1, further comprising generating the unseen mask by aggregating removal region masks warped between views using depth warping and applying a segmentation model to refine the unseen mask using a bounding box prompt.

15. The process of claim 14, wherein the segmentation model comprises a Segment Anything Model (SAM) variant configured to receive the bounding box prompt and output a refined unseen mask.

16. The process of claim 1, wherein the diffusion denoising process is guided using at least one reference image such that inpainted regions are constrained to maintain multiview consistency across the rendered training views.

17. A system comprising:
a first component configured to transform a plurality of input images and masks into a set of 3D Gaussians filtered by unseen masks;
a second component configured to apply the unseen masks, an incomplete depth map, and a reference image to transform the set of 3D Gaussians into depth initialized Gaussians via adaptive guided depth diffusion; and
a third component configured to by apply a diffusion denoising process to the depth initialized Gaussians transform the set of depth initialized Gaussians into a set of images wherein regions corresponding to the unseen masks are inpainted.

18. The system of claim 17, the second component further configured to transform an image latent representation, the incomplete depth map, and the unseen masks by initializing a depth latent with noise and performing reverse diffusion denoising over a plurality of timesteps to generate an aligned depth map.

19. The system of claim 18, wherein, at each timestep of the reverse diffusion denoising, the second component:
generates an intermediate estimated depth map from the depth latent;
determines an adaptive loss between the intermediate estimated depth map and the incomplete depth map within a guided region; and
iteratively updates injected noise applied to the depth latent based on an adaptive loss for a plurality of inner iterations prior to advancing to a next timestep.

20. A non-volatile machine-readable media comprising instructions that, when applied to one or more data processor of a computer system, configure the computer system to:
transform an image latent representation, an incomplete depth map comprising known depth values and missing depth values, and an unseen mask identifying missing regions in the incomplete depth map into a set of depth initialized Gaussians;
render training views from the set of depth initialized Gaussians;
for each rendered training view:
generate a noisy version of the rendered training view by injecting noise across multiple iterations; and
apply a diffusion denoising process to the noisy version of the rendered training view to generate an inpainted image for the training view.
